(19) United States
(12) Patent Application Publication
(10) Pub. No.: US 2006/0208097 A1
(43) Pub. Date: Sep. 21, 2006

(54) Electronic apparatus, unit drive, and interface controlling method of the unit drive

(75) Inventors: Motoaki Ando, Ome-shi (JP); Reina Hosogaya, Hamura-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/437,709

(22) Filed: May 22, 2006

Related U.S. Application Data
(63) Continuation of application No. PCT/JP04/18731, filed on Dec. 15, 2004.

(30) Foreign Application Priority Data
Dec. 19, 2003 (JP) 2003-422350

(51) Int. Cl. G06K 19/06; G06F 12/00

(52) U.S. Cl. 235/492; 711/115

(57) ABSTRACT

According to one embodiment, an electronic apparatus including an driving unit configured to drive an expansion unit which is detachably loaded, and a communication controller configured to control communication with the driving unit via an interface which can be electrically disconnected with power turned on, the driving unit includes a detection unit configured to detect loading/unloading of the expansion unit, and an interface control unit configured to control the interface so as to disable the interface if unloading of the expansion unit is detected by the detection unit and to allow the communication controller to determine enabling/disabling of the interface if loading of the expansion unit is detected.

### CROSS-REFERENCE TO RELATED APPLICATIONS

This is a Continuation Application of PCT Application No. PCT/JP2004/018731, filed Dec. 15, 2004, which was published under PCT Article 21(2) in Japanese.

This application is based upon and claims the benefit of priority from Japanese Patent Application No. 2003-422350, filed Dec. 19, 2003, the entire contents of which are incorporated herein by reference.

### BACKGROUND

1. Field

One embodiment of the invention relates to a power saving technique for a personal computer having a built-in peripheral connected, for example, via a USB interface.

2. Description of the Related Art

In recent years, a peripheral adopting a USB (Universal Serial Bus) interface, i.e. an interface which can be electrically connected or disconnected while the power is turned on, has become widespread. For example, a main body of a personal computer connected to the peripheral needs to detect the connection of the peripheral to efficiently execute the power saving control and the like. Thus, various systems to detect the connection of the peripheral via the USB interface has been proposed (for example, U.S. Pat. No. 6,415,342 and Jpn. Pat. Appln. KOKAI Publication No. 2000-305676).

Incidentally, acceleration of data transfer on the USB interface standards has been promoted. In accordance with this, the number of personal computers including peripherals having the USB interface built in the main bodies thereof has increased.

It is assumed here that an SD card reader of the USB interface specifications to make an access to data on SD (Secure Digital) memory card(R), is built in a main body of a personal computer. According to the method disclosed in U.S. Pat. No. 6,415,342, since the SD card reader is always in a connected state as seen from the system, it is impossible to control the power saving function to become enabled or disabled, for example, in accordance with the loading of the SD memory card(R).

On the other hand, according to the method disclosed in Jpn. Pat. Appln. KOKAI Publication No. 2000-305676, if the SD memory card(R) is not loaded in the SD card reader, existence of the SD card reader can be deleted in the system. However, if the SD memory card(R) is loaded therein, the connected state is fixed under control of the SD card reader side. Thus, it is impossible to positively delete the existence of the SD card reader under control of the system side while loading the SD memory card(R) therein under some conditions, and thereby effectively perform the power saving function.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a part of a structure of an electronic apparatus according to the embodiment of the present invention;

FIG. 2 is an illustration showing an example of a structure of a USB interface control unit, in a USB device built in the electronic apparatus of the embodiment;

FIG. 3 is an exemplary timing chart concerning USB interface control in the electronic apparatus of the embodiment;

FIG. 4 is an exemplary flowchart showing operation steps concerning the USB interface control in the electronic apparatus of the embodiment (USB device side); and

FIG. 5 is an exemplary flowchart showing operation steps concerning the USB interface control in the electronic apparatus of the embodiment (system side).

### DETAILED DESCRIPTION

Various embodiments according to the invention will be described hereinafter with reference to the accompanying drawings. In general, according to one embodiment of the invention, an electronic apparatus including an driving unit configured to drive an expansion unit which is detachably loaded, and a communication controller configured to control communication with the driving unit via an interface which can be electrically disconnected with power turned on, the driving unit includes a detection unit configured to detect loading/unloading of the expansion unit, and an interface control unit configured to control the interface so as to disable the interface if unloading of the expansion unit is detected by the detection unit and to allow the communication controller to determine enabling/disabling of the interface if loading of the expansion unit is detected.

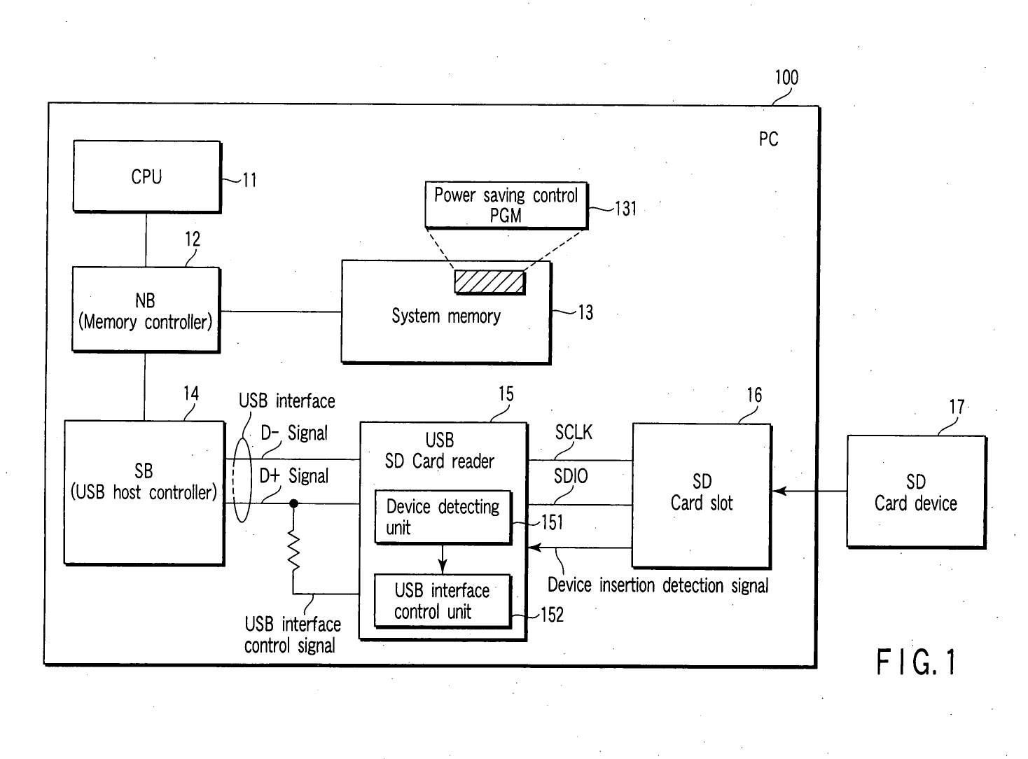

FIG. 1 shows a part of a structure of an electronic apparatus according to the embodiment of the present invention. The electronic apparatus is, for example, a notebook personal computer (PC) and comprises a CPU 11, a north bridge (NB) 12, a system memory 13, a south bridge (SB) 14, a USB-SD card reader 15 and an SD card slot 16.

The CPU 11 is a central unit of the PC 100, controlling all of the units by executing various programs stored in the system memory 13. The NB 12 is a bridge which interconnects a local bus of the CPU 11 and a system bus such as a PCI bus. The NB 12 also has a function of a so-called memory controller, which controls access to data of the system memory 13. In addition, the NB 12 has a function of a so-called display controller which controls display of a display unit (not shown). The system memory 13 is a storage medium serving as a main memory of the PC 100, storing various programs performed by the CPU 11 and various data of the programs. These programs include a power saving control program 131 (a power saving control unit) to be described later.

The SB 14 is also a bridge which interconnects two buses, similarly to the NB 12, and has a function of a USB host controller (a communication controller) which controls communication with the USB-SD card reader 15 adopting the USB interface. On the other hand, the USB-SD card reader 15 connected to the SB 14 by the USB interface is a peripheral (an driving unit) which controls access to the data of the semiconductor memory, i.e. an SD card device 17 (an expansion unit) loaded in the SD card slot 16. It is assumed here that the USB-SD card reader 15 and the SD card slot 16 are built in the main body of the PC 100. In other words, a D+ signal line and a D− signal line for USB interface which make connection between the SB 14 and the USB-SD card reader 15 are physically connected at any time.

The power saving control program 131 is a program which controls the operations of the units to reduce the power consumption for the system of the PC 100. As one of conditions to make the power saving function enabled, it is defined that the USB interface making connection between the SB 14 and the USB-SD card reader 15 is disabled. Therefore, even if the D+ signal line and the D− signal line for USB interface making connection between the SB 14 and the USB-SD card reader 15 are physically connected at any time as a result of providing the USB-SD card reader 15 in the main body of the PC 100, it is preferable to disable the USB interface in a case where, for example, the SD card device 17 is not loaded in the SD card slot 16. Even in a case where the SD card device 17 is loaded in the SD card slot 16, it is preferable to disable the USB interface by the SB 14 side, for example, in preparation for a case where when power is being supplied from a battery (not shown) the remaining power of the battery is less than a predetermined amount or a case where the user clearly instructs that he does not use the SD card device 17. For this reason, the USB-SD card reader 15 of the PC 100 comprises a device detecting unit 151 (a detecting unit) and a USB interface control unit 152 (an interface control unit).

An SCLK line in which a synchronous signal is supplied to the SD card device 17 side and an SDIO line in which the data is transmitted to or received from the SD card device 17 are laid between the USB-SD card reader 15 and the SD card slot 16. In addition, a device insertion detection signal line to notify the USB-SD card reader 15 of the loading of the SD card device 17 by the SD card slot 16 is also laid between the USB-SD card reader 15 and the SD card slot 16. The device detecting unit 151 monitors the state of the device insertion detection signal line to detect the loading of the SD card device 17 in the SD card slot 16, and notifies the USB interface control unit 152 of the detection result. Any means, for example, a mechanical switch may be adopted as the mechanism to detect the loading of the SD card device 17 in the SD card slot 16 if its predetermined purpose can be thereby accomplished. It is assumed here that the device insertion detection signal line is maintained in the High state when the SD card device 17 is not loaded and in the Low state when the SD card device 17 is loaded.

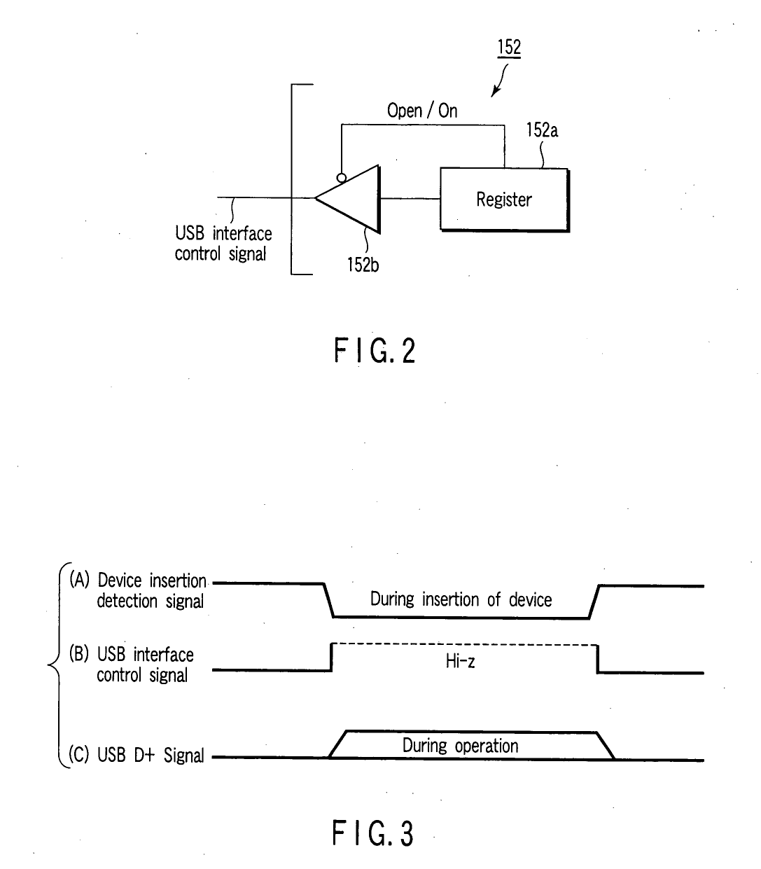

FIG. 2 shows an example of a structure of the USB interface control unit 152. As shown in the figure, the USB interface control unit 152 has a register 152a and a transistor 152b. An output of the transistor 152b is led to a USB interface control signal line shown in FIG. 1. The USB interface control signal line is connected to the D+ signal line for USB interface via a pull-down resistor.

Notification from the device detecting unit 151 to the USB interface control unit 152 is performed in the manner of writing the control data in the register 152a. If the control data indicating that the SD card device 17 is not loaded is stored in the register 152a, ON signal is supplied to the transistor 152b. As a result, the D+ signal line for USB interface is fixed on Low side by the pull-down resistor of the USB interface control signal line, such that the USB interface provided between the SB 14 and the USB-SD card reader 15 is invalidated. In other words, existence of the USB-SD card reader 15 is deleted in the system of the electronic apparatus.

On the other hand, if the control data indicating that the SD card device 17 is loaded is stored in the register 152a, OPEN signal is supplied to the transistor 152b. As a result, the USB interface control signal line becomes in a so-called open state of Hi-z, such that High/Low of the D+ signal line or enabling/disabling of the USB interface provided between the SB 14 and the USB-SD card reader 15 is determined under control of the SB 14 side.

FIG. 3 is a timing chart concerning the USB interface control in the electronic apparatus.

If the SD card device 17 is loaded in the SD card slot 16, the device insertion detection signal line is changed from High to Low. In accordance with this, the USB interface control signal line is changed from Low to Hi-z. As a result, the D+ signal line for USB interface is (basically) changed from Low to High, the existence of the USB-SD card reader 15 is recognized by the system, and access to the data of the SD card device 17 via the USB-SD card reader 15 is executed as the occasion demands.

If the SD card device 17 is unloaded from the SD card slot 16, the device insertion detection signal line is changed from Low to High. In accordance with this, the USB interface control signal line is changed from Hi-z to Low. As a result, the D+ signal line for USB interface is changed from High to Low and the existence of the USB-SD card reader 15 is deleted again in the system.

The SB 14 is basically operated to enable the USB interface provided between the SB 14 and the USB-SD card reader 15, i.e. keep the D+ signal line in the state of High. Therefore, the D+ signal line is High unless the D+ signal line is fixed in Low by the USB-SD card reader 15 side, i.e. if the USB interface control signal line is Hi-z. For example, however, if the SB 14 receives an instruction indicating that the USB interface provided between the SB 14 and the USB-SD card reader 15 should be invalidated from the power saving control program 131, the SB 14 exceptionally controls the D+ signal line to be Low. With this system, the existence of the USB-SD card reader 15 can be deleted in the system while the SD card device 17 is loaded in the SD card slot 16, under the certain conditions described above, i.e. in a case where the electronic apparatus has low battery or a case where the electronic apparatus receives an instruction from the user.

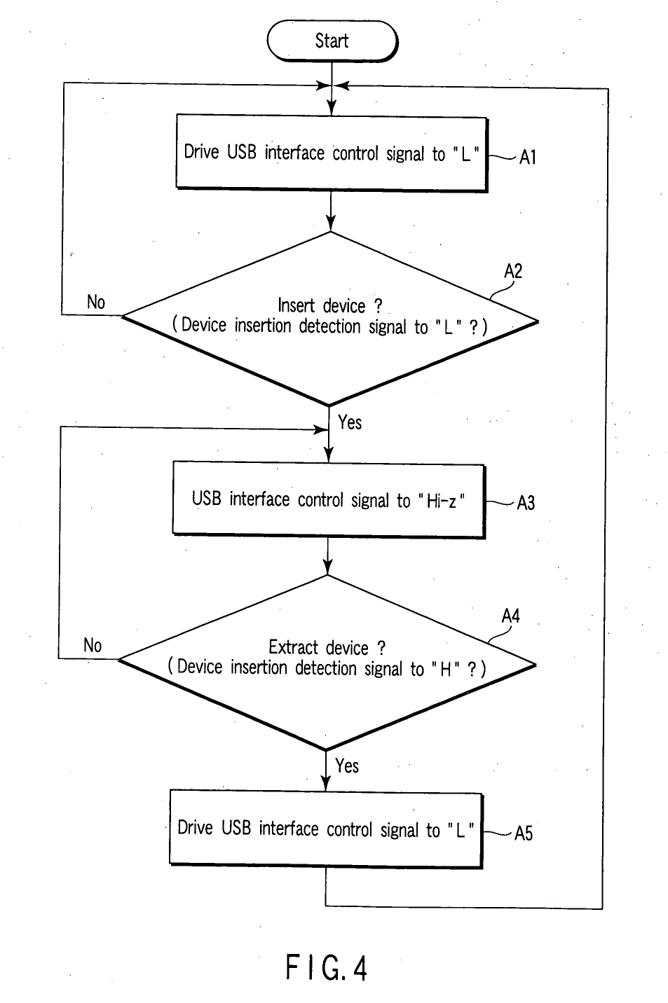

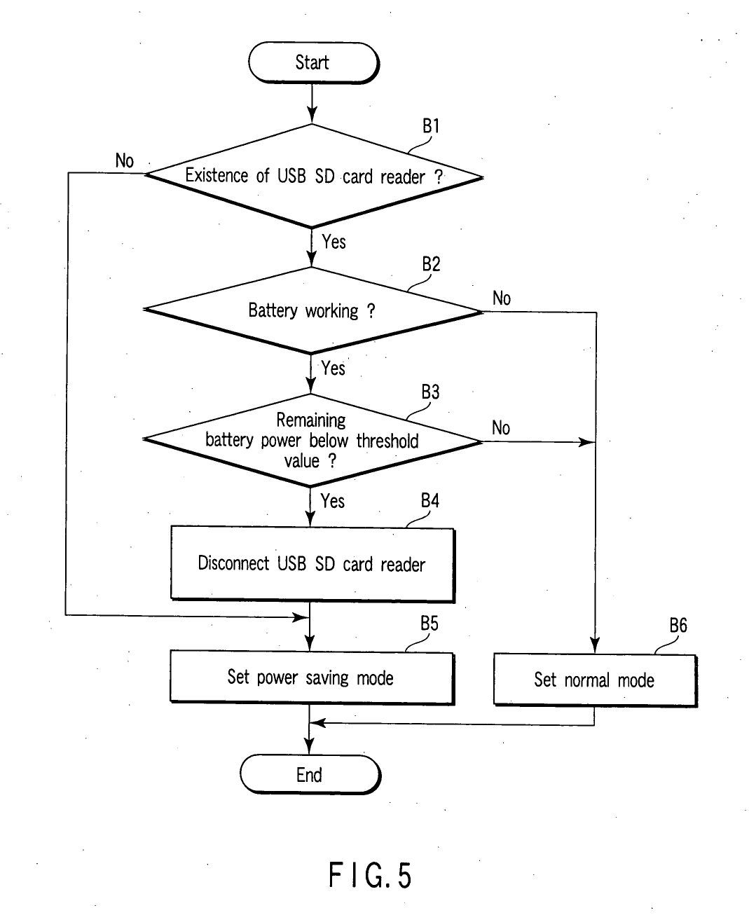

FIG. 4 and FIG. 5 are flowcharts showing the operation steps concerning the USB interface control in the electronic apparatus. FIG. 4 shows the operation steps on the USB card reader 15 side. FIG. 5 shows the operation steps on the system side including the SB 14.

In the USB-SD card reader 15, first, the USB interface control unit 152 controls the USB interface control signal line to be Low (Block A1). Next, the device detecting unit 151 checks the loading of the SD card device 17 in the SD card slot 16 by monitoring the device insertion detection signal line (Block A2). If the SD card device 17 is loaded in the SD card slot 16 (YES of Block A2), the device detecting unit 151 notifies the USB interface control unit 152 of the loading. The USB interface control unit 152 controls the USB interface control signal line to be Hi-z (Block A3).

After that, the device detecting unit 151 checks the unloading of the SD card device 17 from the SD card slot 16 by monitoring the device insertion detection signal line (Block A4). If the SD card device 17 is unloaded from the SD card slot 16 (YES of Block A4), the device detecting unit 151 notifies the USB interface control unit 152 of the unloading. The USB interface control unit 152 controls the USB interface control signal line to be Low (Block A5).

On the other hand, on the system side including the SB 14, if the system recognizes the existence of the USB-SD card reader 15 (YES of Block B1), the power saving control program 131 checks whether or not the battery is working (Block B2). If the battery is working (YES of Block B2), the power saving control program 131 subsequently checks whether or not the electronic apparatus is in a low battery state (Block B3). If the electronic apparatus is in a low battery state (YES of Block B3), the power saving control program 131 supplies an instruction indicating that the USB interface provided between the SB 14 and the USB-SD card reader 15 should be invalidated to the SB 14 (Block B4) and then enables the power saving function of the system (Block B5). The enabling of the power saving function is also executed in a case where the system does not recognize the existence of the USB-SD card reader 15 (NO of Block B1). If the battery is not working (NO of Block B2) or if the battery is working but the electronic apparatus is not in the low battery state (NO of Block B3), the power saving control program 131 allows the power saving function of the system to be disabled (Block B6).

According the electronic apparatus, as described above, the USB interface of the USB-SD card reader 15 controlling the access to the data of the SD card device 17 which can be freely loaded in or unloaded from the SD card slot 16 is controlled properly.

In the above-described embodiment, the USB device built in the main body of the electronic apparatus is the USB-SD card reader 15. For example, however, the method of the USB interface control is effective even if the USB-SD card reader 15 is replaced with a hub which makes connection between the USB interface and a plurality of other electronic apparatuses. In addition, the method of the USB interface control is also effective even if the USB device is not built in the main body of the electronic apparatus but connected to the outside via a cable.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
an driving unit configured to drive an expansion unit which is detachably loaded; and
a communication controller configured to control communication with the driving unit via an interface which can be electrically disconnected with power turned on,
the driving unit includes:
a detection unit configured to detect loading/unloading of the expansion unit; and
an interface control unit configured to control the interface so as to disable the interface if unloading of the expansion unit is detected by the detection unit and to allow the communication controller to determine enabling/disabling of the interface if loading of the expansion unit is detected.

2. The electronic apparatus according to claim 1, wherein the interface is a USB (Universal Serial Bus) interface, and
the interface control unit has a signal line to fix a D+ signal line of the USB interface on a Low side, fixes the D+ signal line on the Low side by controlling the signal line to Low if the interface is invalidated, and opens the D+ signal line by controlling the signal line to Hi-z if the enabling or disabling of the interface is determined by the communication controller.

3. The electronic apparatus according to claim 1, further comprising a power saving control unit configured to inquire of the communication controller whether the interface is validated or invalidated, and invalidating a power saving function of the electronic apparatus to reduce power consumption of the power if the interface is validated,
wherein the communication controller changes enabling and disabling of the interface in accordance with a request from the power saving control unit.

4. The electronic apparatus according to claim 3, further comprising a battery which supplies power to the system of the electronic apparatus,
wherein the power saving control unit requests the communication controller to disable the interface if a remaining power of the battery falls below a predetermined value.

5. The electronic apparatus according to claim 1, wherein the driving unit is a media drive which controls input and output of data of a storage medium loaded as the expansion unit.

6. The electronic apparatus according to claim 1, wherein the driving unit is a hub which bridges data communication with another electronic apparatus loaded as the expansion unit.

7. A unit drive built in an electronic apparatus to drive an expansion unit which is loaded to be freely detachable, the unit drive comprising:
a detection unit configured to detect loading/unloading of the expansion unit; and
an interface control unit configured to control the interface so as to disable an interface which makes connection with a system of the electronic apparatus if unloading of the expansion unit is detected by the detection unit and to allow the system of the electronic apparatus to determine enabling/disabling of the interface if loading of the expansion unit is detected.

8. The unit drive according to claim 7, wherein the interface is a USB interface, and
the interface control unit has a signal line to fix a D+ signal line of the USB interface on a Low side, fixes the D+ signal line on the Low side by controlling the signal line to Low if the interface is invalidated, and opens the D+ signal line by controlling the signal line to Hi-z if the enabling or disabling of the interface is determined by the system of the electronic apparatus.

9. An interface controlling method of a unit drive built in an electronic apparatus to drive an expansion unit which is loaded to be freely detachable, the method comprising:
detecting loading/unloading of the expansion unit; and
controlling the interface so as to disable an interface which makes connection with a system of the electronic apparatus if unloading of the expansion unit is detected and to allow the system of the electronic apparatus to determine enabling/disabling of the interface if loading of the expansion unit is detected.

10. The method according to claim 9, wherein the interface is a USB interface, and
a signal line to fix a D+ signal line of the USB interface on Low side is controlled to be Low and the D+ signal line is fixed on the Low side if the interface is invalidated, and the signal line is controlled to be Hi-z and the D+ signal line is opened if the enabling or disabling of the interface is determined by the system of the electronic apparatus.
